(19) United States
(12) Patent Application Publication
(10) Pub. No.: US 2016/0332437 A1
(43) Pub. Date: Nov. 17, 2016

(54) Solder Paste Stencil with Integral Stiffener and Mounting Device

(71) Applicants: Arthur Guidi, St. Petersburg, FL (US); Lisa Guidi, St. Petersburg, FL (US); Kristian Guidi, St. Petersburg, FL (US)

(72) Inventors: Arthur Guidi, St. Petersburg, FL (US); Lisa Guidi, St. Petersburg, FL (US); Kristian Guidi, St. Petersburg, FL (US)

(21) Appl. No.: 14/709,449

(22) Filed: May 11, 2015

(51) Int. Cl. B41F 15/34

(52) U.S. Cl. CPC B41F 15/34

(57) ABSTRACT

A secondary framing system for printing screen utilizing four (4) mount/stiffeners permanently welded to the printing screen allowing the printing screen assembly to by mounted to mechanical tensioning mechanism. There are no separate parts to be assembled by the user of the printing screen assembly. There no other attaching method required for the mount/stiffener as in other printing screen mounting methods. The thickness of the welded assembly allows users to store more printing screen assemblies in less space.

### CROSS-REFERENCE TO RELATED APPLICATIONS

Not Applicable

### BACKGROUND

The present invention relates to printing screens, often alternatively referred to as stencils or masks, for use in the screen printing of workpieces, typically electronic substrates, such as circuit boards and components, frames therefor, and printing screen units.

In one known printing screen unit, the printing screen comprises a thin, stiff metal sheet, typically of stainless steel or brass, which includes a plurality of printing apertures which define a pattern for the printing of a printing medium, typically solder paste. The printing screen is mounted to a rectangular frame by a flexible, perforate sheet, typically a woven mesh of polypropylene or stainless steel strands, which acts to tension the printing screen.

While the above-described printing screen unit has been well used, the unit does have a number of drawbacks, notably in being expensive to fabricate, and not allowing for the printing screen to be detached from the frame without permanently damaging the perforate sheet.

In subsequent generation of a printing screen unit, the printing screen is a demountable printing screen which comprises a thin, stiff metal sheet, typically of stainless steel, which includes a plurality of printing apertures which define a pattern for the printing of a printing medium, typically solder paste, and a plurality of fixing apertures at opposite edges thereof. The printing screen is mounted to a frame by mechanical tensioning mechanisms which engage the fixing apertures in the printing screen and act to tension the printing screen, with the tensioning force typically being provided by hydraulic, pneumatic or spring means.

These printing screen units, in not requiring the permanent attachment of a printing screen to a frame, advantageously allow for printing screens to be stored separately and mounted on frames as and when required, thereby being cheaper and facilitating use.

These printing screen units suffer from a number of drawbacks. In particular, the edges of the printing screens are required to be more flexible than the main body thereof, and, as such, are more prone to damage during handling and mounting. This is particularly the case as the printing screens are stored as unsupported sheets. Also, as the printing screens are very thin, typically having a thickness of from about 0.004 to 0.015 mm, the edges thereof are razor sharp, which can lead to personal injury to a user if not handled properly.

In yet a further subsequent generation printing screen unit, the printing screen comprises a thin, stiff metal sheet, typically of stainless steel, which includes a plurality of printing apertures which define a pattern for the printing of a printing medium, typically solder paste. The printing screen is mounted to a secondary frame via adhesive bonding, compression bonding, or crimping. The stencil and frame can be installed in mechanical tensioning mechanisms which engage the secondary frame and act to tension the printing screen unit, with the tensioning force typically being provided by hydraulic, pneumatic or spring means.

These generation printing screen units resolved the aforementioned issues with the previous generation, as the secondary frames prevented damage during handling and storage and eliminated the sharp edges from the units.

While this generation resolved issues with the previous generation, the frames that could be compression bonded or crimped were intricate and expensive to manufacture. Additionally, the process for adhesive bonding the printing screens to the frames was messy and time consuming.

### SUMMARY

The aim of the present invention is to provide an apparatus that can overcome the detailed issues that can arise with the manufacturing of printing screen units as well as provide additional benefits.

One aim of the invention is to provide a frame for printing screen units that can be economically manufactured.

Another aim of the invention is to provide a frame for printing screen units that can be simply affixed to the printing screen.

Another aim of the invention is to provide printing frame unit with a thinner profile than its predecessors to allow easier storage.

Another aim of the invention is to provide printing frame unit without no seams to gather and hold solder paste within in use, making the printing fame unit easier to clean.

The final aim of the invention is to provide printing frame unit that is more aesthetically pleasing than its predecessors.

The printing frame unit of the present invention includes a printing screen with a permanently affixed secondary frame along to two pair of opposite edges. The secondary frame is affixed to the printing screen via welding. The outer edges of the secondary frame have an engagement apparatus for engagement to a mechanical tensioning mechanisms.

Each secondary frame member includes an attachment surface which in use is attached to the at least one mechanical tensioning mechanism at a respective edge of the printing screen unit.

Preferably, the attachment surface of each secondary frame member is inclined inwardly from a free edge of the attachment surface relative to the respective edge of the sheet.

More preferably, the attachment apparatus surface of each secondary frame member is defined by a continuous surface.

Preferably, the secondary frame is constructed of a corrosion resistant, high resistance metal alloy.

Preferably, the secondary frame is affixed to the printing screen via a resistance welding method.

More preferably, the secondary frame is affixed to the printing screen via a plurality of spot welds.

The present invention provides an improved printing screen unit which is compatible with existing mechanical tensioning mechanisms, with the secondary frame members resistance welded directly to the printing screen, reducing the complexity of the secondary frame when compared to a compression bonded or crimped frame, thereby significantly reducing the overall cost of the printing screen unit. Further, resistance welding the frame directly to screen eliminates the need for upper and lower sections to form a crimped or compression bonded connection, thereby reducing the thickness of the frame requiring less space for the printing screen unit during storage.

Welded printing screen units provide a significant advantage over their crimped and compression bonded counterparts, because with these units oftentimes the edges of the print screens have to be modified with a plurality of perforations to adapt the printing screen to accept the frame. Creating these perforations is time consuming and requires expensive and specialized tooling. However, the resistance welding design of this invention only requires the purchase of a resistance welder, a relatively modest cost, and less time.

Welded printing screen units provide a significant advantage over their adhesive bonded counterparts because the process is much cleaner, quicker, and reliable. Application of the adhesive bonding to adhere the frame to the printing screen is a difficult and messy process that is avoided using a welded frame. The use of adhesive requires the constructed frame assembly to cure for a significant amount of time between adhesion of the frame and use, whereas a welded frame is available for use immediately. Additionally, a welded bond is more uniform and stronger than an adhesive bond, reducing the risk of failure or creep from repeated tensioning cycles of the print screen assembly.

Welded printing screen units provide a significant advantage over bother their adhesive bonded counterparts and their crimped and compression bonded counterparts because the frames are easier to clean after use. A welded frame is nearly seamless, leaving little or no areas where the solder paste can accumulate, whereas the secondary frames that utilize adhesives, crimping, and compression bonding methods are often intricate with numerous recesses where solder paste can accumulate, making these units more difficult to clean.

As detailed above, the use of secondary frames in creating printing screen units is within the knowledge of one skilled in the art of building printing screen units. Additionally, the resistance welding technique is not a novel technique. However, using a resistance welding technique to assemble a printing screen unit is a novel technique that is not within the level of ordinary skill for one skilled in the art of building printing screen units.

As noted above, the historical methods used to construct printing screen units utilized adhesives and compression or crimped bonding to assemble the units. These methods, while more costly or time consuming, were preferred because they created a uniform bond across the attachment surface that resulted in uniform tensioning across the printing screen when tensioned.

Welding, as a method of assembling a printing screen unit, was not used because it was difficult to create a uniform bond across the attachment surface, which resulted in non-uniform tensioning across the printing screen when tensioned. A non-uniformly tensioned printing screen cannot be used to print a circuit board.

The printing frames developed in this invention, in conjunction with the resistance welding technique described in the detailed description allows one skilled in the art of building printing screen units to construct a welded printing screen unit that enjoys all of the benefits described above.

### BRIEF DESCRIPTION OF THE DRAWINGS

For a better understanding of the particular embodiments of the present invention reference may be made to the following drawings exemplary of the invention, in which:

FIG. 1 is a perspective view drawing of a fully assembled printing screen unit

FIG. 2 overhead view drawing illustrating of the printing screen;

FIG. 3 illustrates a sectional view of the secondary frame member;

FIG. 4 illustrates a plan view of the underside of a fully assembled and welded printing screen assembly;

FIG. 5 illustrates a sectional view through a weld region of the secondary frame member as attached to the welding tabs on the printing screen;

### DETAILED DESCRIPTION OF THE INVENTION AND PREFERRED EMBODIMENT

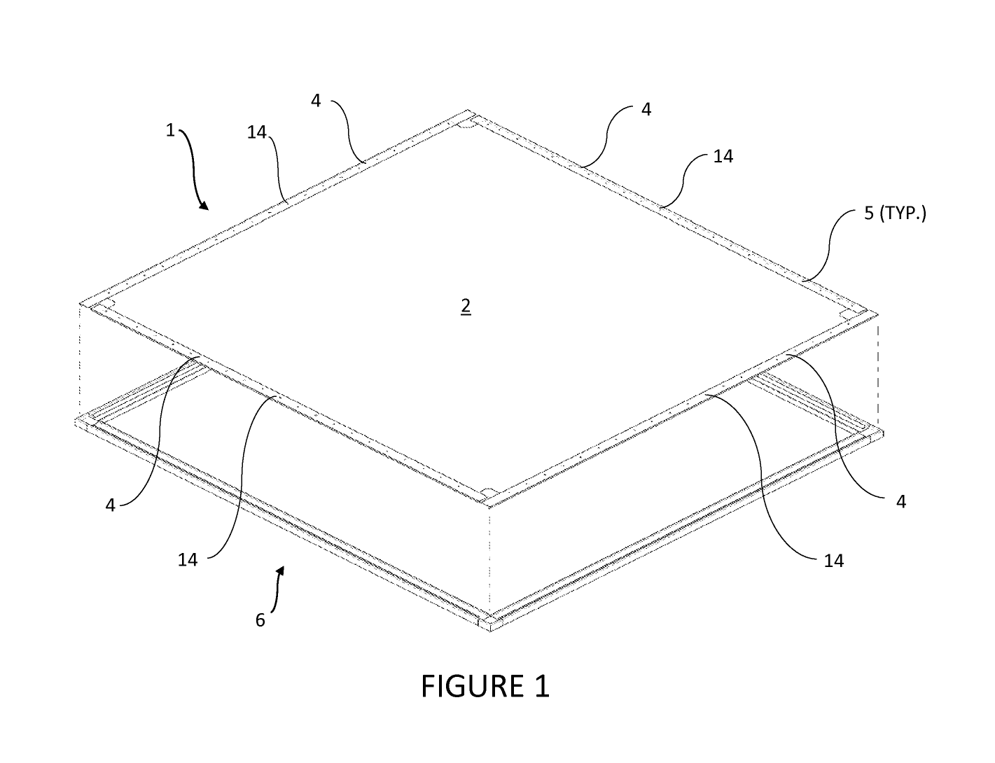

FIG. 1 illustrates a printing screen assembly 1 in accordance with a preferred embodiment of the present invention. The printing screen assembly comprises a printing screen 2, in this embodiment of square shape with chamfered corners 3 and first and second pairs of secondary frame members 4 which are attached to the respective pairs of opposite edges of the printing screen 2 via a plurality or resistance spot welds 5. The assembled printing screen unit 1 is installed into a mechanical tensioning mechanism 6.

In order for the resistance welding technique to be successful, both the printing screen 2 and the secondary frame members 4 must be constructed of a high resistance metal alloy such as stainless steel.

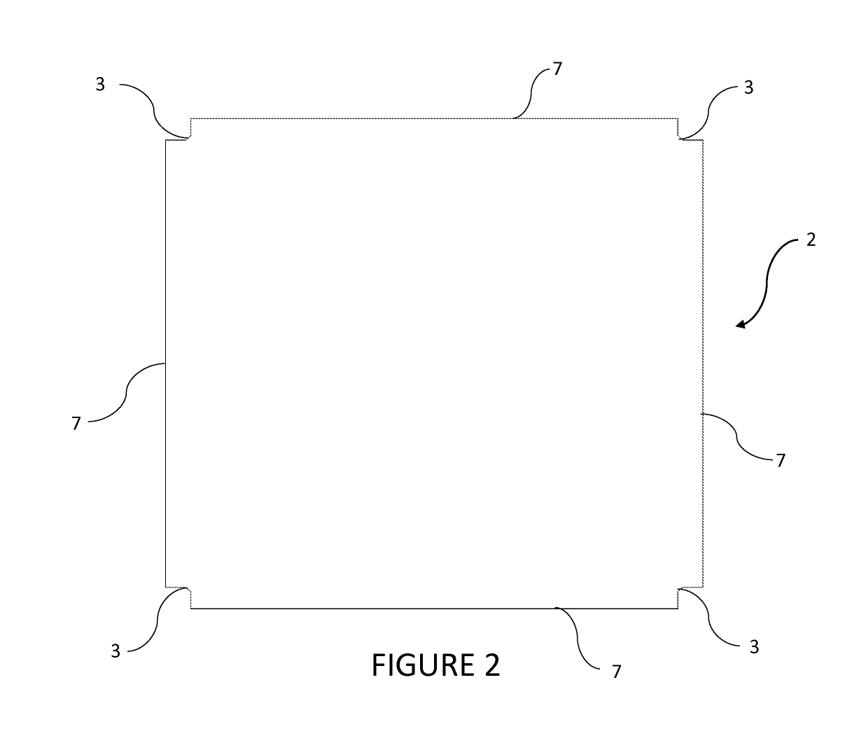

Referring to FIG. 2, in the preferred embodiment the corners of the printing screen 2 are chamfered 3. The chamfered corners 3 provide flexibility to the assembled printing screen unit so that it is easier to install in a mechanical tensioning mechanism. While the chamfered corners 3 are preferred because they provide additional flexibility to the printing screen 2, they are not considered critical to the invention.

Referring to FIG. 2, in the preferred embodiment the print screen has welding tabs 7 protruding beyond the chamfered edges 3 of the printing screen 2, slightly shorter than the weld surface 8 of the secondary frames 4. The welding tabs 7 provide a surface for welding the secondary frames 4 to the printing screen 2. While the welding tabs 7 are preferred because they provide additional flexibility to the printing screen 2, they are not considered critical to the invention, as the secondary frame members 7 could be welded directly to the printing screen 2.

Referring to FIG. 2, in the preferred embodiment the welding tabs 7 of the printing screen 2 to which the secondary frame members 4 are to be attached each comprise a clean straight edge.

Referring to FIG. 1, in the preferred embodiment the secondary frame members 4 each extend along and beyond the length of the respective edge of the welding tabs 7 to form a right angle. The corners 9 of the two perpendicular secondary frame members are not connected. Not affixing the secondary frame members 4 to each other ensures uniform tension throughout the print screen 2 once the print screen assembly 1 is installed in a mechanical tensioning mechanism 6.

While not preferred, alternatively the corners 9 of the perpendicular secondary frames could be affixed to each other using slip fit corner pieces (not pictured) that allow freedom of movement between the perpendicular secondary frame members 4 when the print screen assembly 1 is installed in the mechanical tensioning system 6 and the system is engaged.

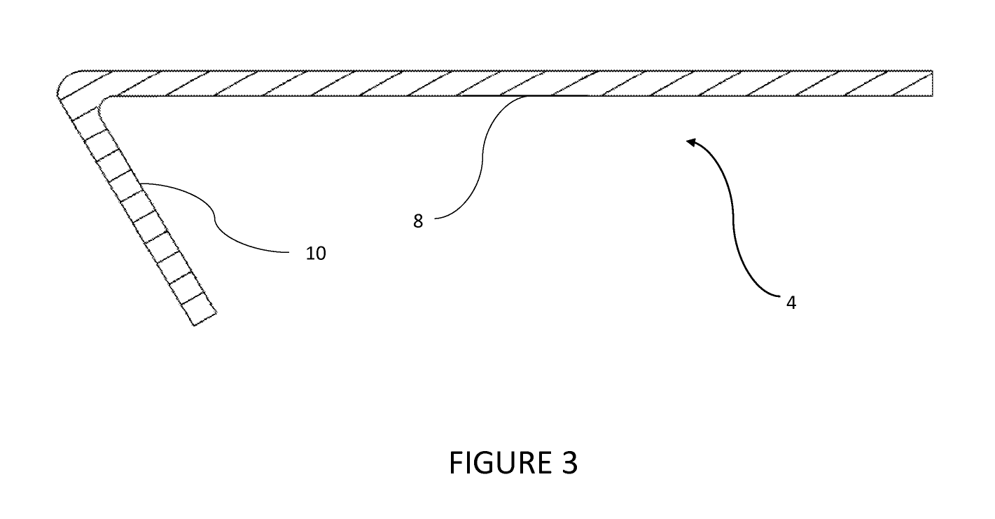

Referring to FIG. 3 in the preferred embodiment the secondary frame members 4 include an attachment surface 10, in this embodiment defined by a continuous surface, which extends along the length of the secondary frame members 4. The attachment surface 10 is inwardly inclined from the outside edge of the secondary frame member 4, such as to define a hook arrangement which provides for captive engagement with a mechanical tensioning mechanism.

The inwardly inclined hook arrangement of the preferred embodiment was chosen because this arrangement interfaces with the standard mechanical tensioning mechanism 6 used in the industry. It should be noted that if new mechanical tensioning mechanisms are developed that would require a different type of interface other than an inwardly inclined hook arrangement that it would be within the capabilities of one skilled in the art or making stencil frames, to make the necessary adjustments to the attachment surface to adapt to a different type of mechanical tensioning mechanism.

Referring to FIG. 3 in the preferred embodiment the secondary frame members 4 include a weld surface 8, in this embodiment defined by a continuous surface, which extends along the length of the secondary frame members 4. The weld surface provides an interface for welding the secondary frame 4 to the printing screen 2.

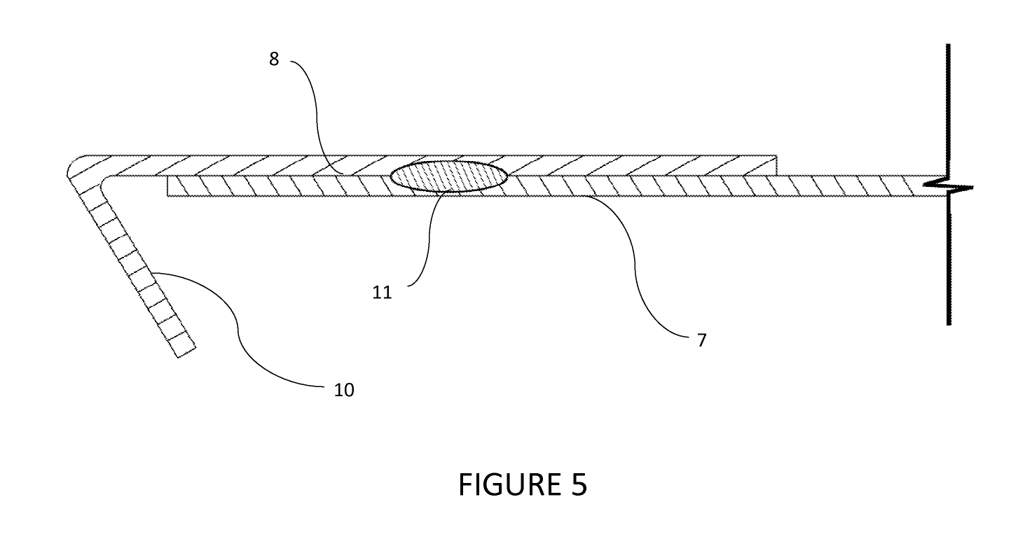

Referring to FIG. 5 In the preferred embodiment, the printing screen 2 and the secondary frame members 4 are permanently affixed to each other using a resistance welding technique. The weld surface 8 of the secondary frames are aligned with the welding tabs 7 on the printing screen 2 such that the two parts overlap, and the two are then welded together using a resistance welding technique.

Resistance welding is a technique used to join two or more overlapping metal sheets. In resistance welding, the heat to form the weld is generated by the electrical resistance of material combined with the time and the force used to hold the materials together during welding. Small circular pools of molten metal are formed at the point of most electrical resistance as an electrical current is passed through the metal. The hardened pools of molten metal are referred to as weld nuggets 11. Resistance welding is the preferred method for joining the print screen 2 and the secondary frame members 4 because using resistance welding there is little weld deformation created during the welding, resulting in a uniform printing screen structure that will uniformly tension when installed in a mechanical tensioning mechanism.

When using resistance welding to join the secondary frame members 4 and the printing screen 2, a resistance spot welder is preferred. The welder preferably utilizes an AC current for welding, as AC current is ideal for welding high resistance metal alloys such as stainless steel.

When using a resistance spot welder, two vertical copper electrodes are simultaneously used to compression clamp the horizontally positioned printing screen 2 and secondary frame members 4 together and to pass current through the printing screen 2 and secondary frame members 4. The in the preferred embodiment the top electrode should be a radiused tip design and the bottom electrode should be a flat tip with a larger cross sectional tip area than the top electrode.

When welding, the welder will carefully align the printing screen 2 and the secondary frame members 4 so that the welding tab 7 and weld surface 8 overlap and that the two edges are parallel to each other. Once aligned two corners are held in alignment by a welding fixture. The printing screen 2 and the secondary frame member 4 are then placed into the clamping device on the resistance welder so that the electrode tips are in the center of the overlapping area of the welding tab 7 and weld surface 8. The welding tabs 7 and weld surface 8 should be aligned so that pointed electrode tip is in contact with the weld surface 8 and the flat electrode tip is in contact with the welding tab 7.

Once the welding tab 7 and weld surface 8 are in the resistance welder clamping device, the operator must follow the weld schedule, holding the two in place for the appropriate squeeze time, applying electric current for the appropriate weld time, and leaving the two items in the clamping mechanism for the appropriate hold time before removing the pressure from the clamping device.

A weld schedule will need to be developed based on the type of material and the thickness of the material which comprises the welding tab 7 and weld surface 8. The weld schedule will detail: 1) Top Electrode Diameter, 2) Electrical Current, 3) Clamp Pressure, 4) Squeeze Time (time between the initial application of the electrode force on the work and the first application of electrical current), 4) Weld Time (time that welding current is applied to the work), and 5) Hold Time (time during which force is applied at the point of welding after the last pulse of current ceases).

Many resistance welding machine and electrode suppliers offer standard weld schedules for common metal combinations which can act as a guide to creating a weld schedule for affixing the secondary frame to the printing screen, however, a specific weld schedule should be developed for the secondary frame members 4 and printing screen 2 materials of construction and thickness. Specific weld schedules are developed using a trial and error method, where the five factors above are adjusted until a desired weld nugget is achieved.

The main method for verification of spot weld quality is a destructive test known as the peel test, where-by spot welds are torn apart by an externally applied force and the parent metal breaks away from the weld zone. The weld nugget is revealed and assessed for it quality and to ensure it is fit for purpose. Welds are broken apart in the peel test by clamping one of the welded sheets, typically in a vice. The other welded sheet is gripped by either; pliers, pincers or a roller tool and force is applied in such a way that the weld is loaded perpendicular to its original orientation, thus peeling the weld open.

Destructive peel testing results in a weld nugget 11 that has been torn out of one the metal sheets, the exposed weld area can be measured. This measurement of weld size is typically used as an indication of weld quality. A recommended weld diameter is 5√t, where t is the combined thickness of the welding tab 7 and weld surface 8. Welds with smaller diameter may not have sufficient penetration and the size of the weld is not enough to bear the stress placed on the welds when the frame is installed in the mechanical tensioning mechanism 6. If there is no weld nugget 11 to measure, or the weld nugget 11 is very small, then one or more of the following factors should be increased: Electrical Current, Clamp Pressure, Squeeze Time, Weld Time, and Hold Time. Testing should be repeated until a desired weld nugget 11 is achieved.

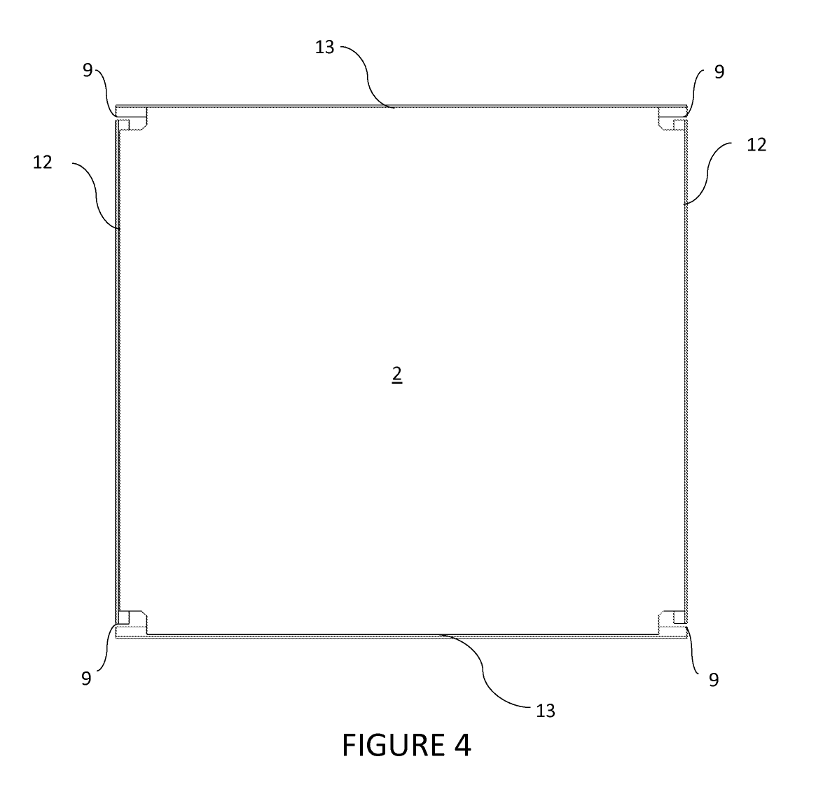

Referring to FIG. 4, according to the preferred embodiment, once a weld schedule has been developed the printing screen 2 and secondary frame members 4 can be attached to one another. Before welding, the weld surfaces 8 should be aligned with the welding tabs 7 so that the two run parallel to each other, to ensure an even distribution of tensile forces when engaged with the mechanical tensioning mechanism 6. Additionally, the weld surfaces 8 should be aligned with the welding tabs 7 so that the distance between the attachment surfaces of the adjacent first 12 and second pairs 13 of secondary frame members 4 is sufficiently long that the fully assembled printing screen assembly 1 can be installed into the mechanical tensioning mechanism 6.

In the preferred embodiment, when resistance spot welding the two components to one another, ideally, the first weld 14 should be the two centermost weld(s) on each of the welding tabs 7. Once the centermost weld(s) have been created, the welder should then work her way to the outside edge of the welding tab 7, spacing spot welds approximately one and one-half inches apart. Because of the heat generated during resistance welding one has to be careful to sequentially weld from the center of the welding tab 7 out to one edge and then from the middle to the other edge. This will ensure that there will not be any distortion along the weld area. While the spacing for the preferred embodiment is approximately one and one-half inches, the spacing between welds can vary based on the size of the final weld nugget 11 achieved and amount of pressure that the mechanical tensioning mechanism 6 places on the secondary frames 4.

Once the secondary frames 4 have been welded to the printing screen 2 the printing screen assembly 1 is complete. The printing screen assembly 1 can be installed into the mechanical tensioning mechanism 6, and once tension has been applied the printing screen assembly 1 is ready for printing.

It would be appreciated by those skilled in the art that various changes and modifications can be made to the illustrated embodiments without departing from the spirit of the present invention. All such modifications and changes are intended to be covered by the appended claims.

1. A secondary framing system for mounting a printing screen in a mechanical tensioning system comprising first and second pairs of secondary frame members for attaching to opposite sides of a printing screen, each frame member is independent and not connected to the other frame members and can be independently aligned with the printing screen when welded to the printing screen each comprising:
an attachment surface which provides means for captive engagement of the secondary frame members with a mechanical tensioning mechanism; and
a welding surface which provides an interface for welding the secondary frame members to the printing screen.

2. The secondary framing system for mounting a printing screen in a mechanical tensioning system comprising of claim 1, wherein said attachment surface consists of an inwardly inclined hook arrangement.

3. A printing screen unit comprising:
a printing screen, comprising a sheet having two pairs of opposite edges; and,
a secondary framing system for mounting a printing screen in a mechanical tensioning system comprising at first and second pairs of frames for attaching to opposite sides of a printing screen;
wherein each frame member is independent and not connected to the other frame members and can be independently aligned with the printing screen when welded to the printing screen and each frame member includes an attachment surface which provides means for captive engagement of the secondary frame with a mechanical tensioning mechanism;
wherein each frame member includes a welding surface which provides an interface for welding the secondary frame members to the printing screen; and,
wherein the means for affixing the secondary frame to the printing screen is resistance welding.

4. The printing screen unit of claim 3, wherein said attachment surface consists of an inwardly inclined hook arrangement.

5. The printing screen unit of claim 3, wherein said welding technique is resistance spot welding

6. The printing screen unit of claim 5, wherein said attachment surface consists of an inwardly inclined hook arrangement.

7. A method for constructing a printing screen unit wherein at first and second pairs of secondary frame members are resistance welded to opposite sides of a printing screen;
wherein each frame member is independent and not connected to the other frame members and can be independently aligned with the printing screen when welded to the printing screen and each frame member includes an attachment surface which provides means for captive engagement of the secondary frame with a mechanical tensioning mechanism.

8. The method for constructing a printing screen unit of claim 7, wherein said attachment surface consists of an inwardly inclined hook arrangement.

9. The method for constructing a printing screen unit of claim 7, wherein said welding technique is resistance spot welding.

10. The method for constructing a printing screen unit of claim 9, wherein said attachment surface consists of an inwardly inclined hook arrangement.
